(19) United States
(12) Patent Application Publication
(10) Pub. No.: US 2017/0099317 A1
(43) Pub. Date: Apr. 6, 2017

(54) COMMUNICATION DEVICE, METHOD AND NON-TRANSITORY COMPUTER-READABLE STORAGE MEDIUM

(71) Applicant: FUJITSU LIMITED, Kawasaki-shi (JP)

(72) Inventors: Hirotaka KOKUBO, Minato (JP); Kazuyoshi Furukawa, Kawasaki (JP); Masahiko TAKENAKA, Kawasaki (JP); Mebae Yamaoka, Kawasaki (JP); TAKANORI OIKAWA, Kawasaki (JP)

(73) Assignee: FUJITSU LIMITED, Kawasaki-shi (JP)

(21) Appl. No.: 15/270,465

(22) Filed: Sep. 20, 2016

(30) Foreign Application Priority Data
Oct. 2, 2015 (JP) 2015-196481

(51) Int. Cl. H04L 29/06; G06F 9/455

(52) U.S. Cl. CPC H04L 63/1441; H04L 63/10; G06F 9/45558

(57) ABSTRACT

A communication device includes a memory configured to store information that defines permission and prohibition of access to another communication device from the communication device, and a processor coupled to the memory and configured to in a state where the information is not referenced by an operating system (OS), run the OS, when an access request to the another communication device is received from an application, based on the information, perform a determination of permission or prohibition of access to the another communication device, and based on a result of the determination, perform accessing to the another communication device or rejecting the access request.

### CROSS-REFERENCE TO RELATED APPLICATION

This application is based upon and, claims the benefit of priority of the prior Japanese Patent Application No. 2015-196481, filed on Oct. 2 2015, the entire contents of which are incorporated herein by reference.

### FIELD

The embodiments discussed herein are related to a communication device, a method and a non-transitory computer-readable storage medium.

### BACKGROUND

Security administrators (hereinafter also simply called administrators) in enterprises and organizations have to protect information from, for example, fraudulent acquisition, damage, or the like caused by malware. Malware is a general term used to denote malicious software including computer viruses.

Specifically, malware is, for example, sent in such a manner as to be attached to an e-mail message that a malicious person sends from an external terminal device (hereinafter also simply called an external terminal), and, in a terminal device that receives the e-mail message, the malware is executed, thereby infecting the terminal device. This allows the malicious person to use the terminal device infected with the malware (hereinafter simply called an infected terminal) as a stepping-stone and to thus have unauthorized access to another terminal device coupled to the terminal device and perform fraudulent acquisition or the like of information. Related art documents are Japanese Laid-open Patent Publication No. 2009-253811 and Japanese National Publication of International Patent Application No 2014-514551.

### SUMMARY

According to an aspect of the invention, a communication device includes a memory configured to store information that defines permission and prohibition of access to another communication device from the communication device, and a processor coupled to the memory and configured to in a state where the information is not referenced by an operating system (OS), activate the OS, when an access request to the another communication device is received from an application, based on the information, perform a determination of permission or prohibition of access to the another communication device, and based on a result of the determination, perform accessing to the another communication device or rejecting the access request.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram for explaining an overall configuration of an information processing system 10;

FIG. 2 is a diagram for explaining a specific example when a malicious person sends malware to a terminal device 1c;

FIG. 3 is a diagram for explaining the specific example when the malicious person sends malware to the terminal device 1c;

FIG. 4 is a diagram for explaining the specific example when the malicious person sends malware to the terminal device 1c;

FIG. 5 is a diagram for explaining the specific example when the malicious person sends malware to the terminal device 1c;

FIG. 6 is a diagram for explaining the specific example when the malicious person sends malware to the terminal device 1c;

FIG. 7 is a diagram for explaining the specific example when the malicious person sends malware to the terminal device 1c;

FIG. 8 is a diagram for explaining a specific example of a terminal device 1 according to the present embodiments;

FIG. 9 is a diagram for explaining the specific example of the terminal device 1 according to the present embodiments;

FIG. 10 is a diagram for explaining a hardware configuration of the terminal device 1;

FIG. 11 is a functional block diagram of the terminal device 1 illustrated in FIG. 10;

FIG. 12 is a flowchart for explaining an outline of a communication control process in a first embodiment;

FIG. 13 is a flowchart for explaining the outline of the communication control process in the first embodiment;

FIG. 14 is a flowchart for explaining details of the communication control process in the first embodiment;

FIG. 15 is a flowchart for explaining details f the communication control process in the first embodiment;

FIG. 16 is a diagram for explaining a specific example of control information 131; and

FIG. 17 is a diagram for explaining another specific example of the control information 131.

### DESCRIPTION OF EMBODIMENTS

An infected terminal infected with malware, for example, performs communication with an external terminal that has sent the malware (hereinafter also called callback communication), and waits until an instruction is received from a malicious person. Then, upon receiving the instruction, the infected terminal begins, for example, fraudulent acquisition or the like of information in accordance with the content of the instruction.

To address this, the administrator interrupts communication between the infected terminal and an external terminal, for example, in a network device that relays communication between the infected terminal and the external terminal. That is, the administrator inhibits information from fraudulent acquisition or the like performed by the malicious person by interrupting callback communication between the infected terminal and the external terminal. This allows the administrator to inhibit information from fraudulent acquisition or the like even when infection of the terminal has occurred.

However, when an infected terminal is a portable terminal device (for example, a tablet terminal or the like), in some locations where the infected terminal is used, the infected terminal may bypass a network device that interrupts communication, and perform communication with an external terminal. Therefore, for example, when the infected terminal is used outside the company, or the like, the administrator is not able to interrupt callback communication.

For this situation, in some cases, the administrator installs, for example, a program for controlling communication in an operating system (OS), or the like, in each terminal device. Then, the administrator, for example, sets information about another terminal device (including an external terminal) with which communication has to be prohibited, in each terminal device.

Thereafter, when performing communication with another terminal device, each terminal device itself performs a determination of whether or not communication with the other terminal device is prohibited. This enables each terminal device when prohibited from communicating with another terminal device to voluntarily stop communicating with the other terminal device. Therefore, in this case, the administrator is allowed to interrupt callback communication regardless of the location where the terminal device is used.

However, when malware with which an infected terminal is infected is malware that performs advanced operations, control of the OS of the infected terminal is likely to be taken over by the malware. Then, in this case, processing for interrupting callback communication is likely to be not performed by the OS, making it unlikely to interrupt callback communication.

### Configuration of Information Processing System

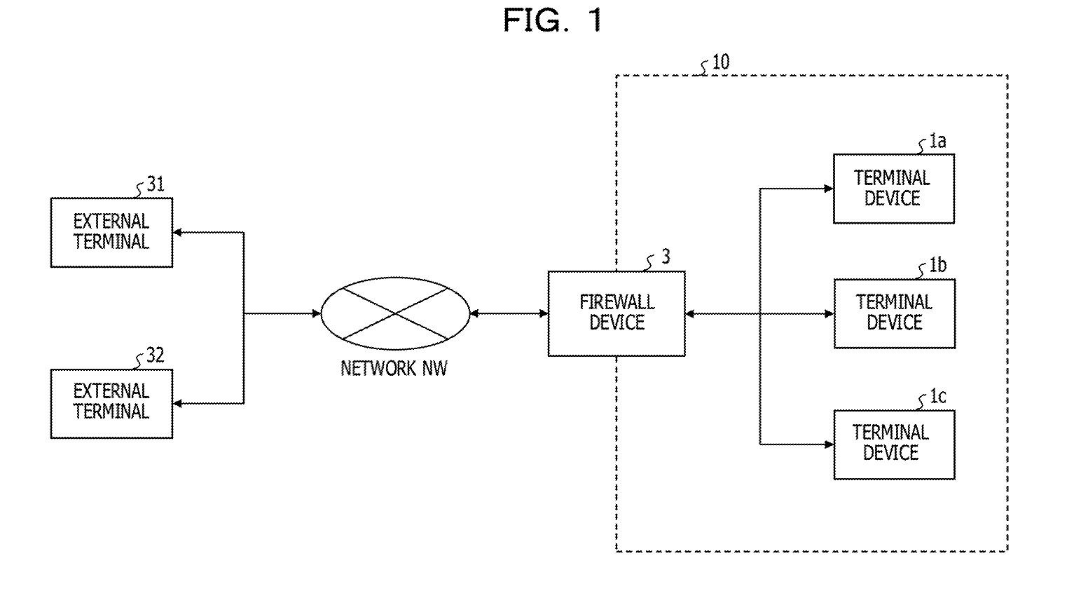

FIG. 1 is a diagram for explaining an overall configuration of an information processing system 10. The information processing system 10 illustrated in FIG. 1 includes terminal devices 1a, 1b, and 1c (hereinafter also called communication control devices 1a, 1b, and 1c, respectively) and a firewall device 3.

The terminal device 1a, 1b, and 1c (hereinafter also generically called terminal devices 1) are terminals that the developers and administrators of business systems in enterprises and organizations (hereinafter also simply called users) use. Specifically, the terminal devices 1 are, for example, desktop personal computers (PCs) and notebook PCs.

The firewall device 3 controls communication between an external terminal 31 or an external terminal 32 coupled to a network NW, and the terminal device 1. That is, the firewall device 3 performs processing in which, for example, when a malicious person attempts to have unauthorized access to the terminal device 1 via the external terminal 31 or the external terminal 32, this access is prohibited. Note that the network NW is, for example, an Internet network.

### Specific Example of Case Where Malware is Sent from External Terminal

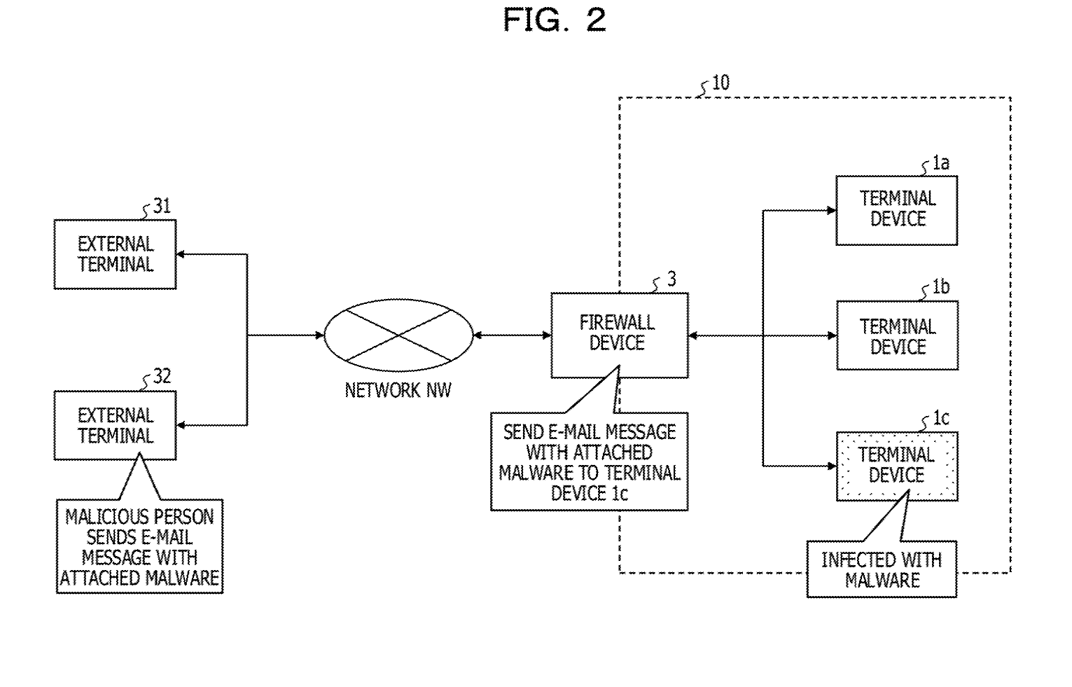

Next, a specific example of the case where a malicious person sends malware via the external terminal 32 to the terminal device 1c will be described. FIG. 2 to FIG. 7 are diagrams for explaining a specific example of the case where a malicious person sends malware to the terminal device 1c.

As illustrated in FIG. 2, the malicious person sends an e-mail message to which malware is attached (an e-mail message disguised as a normal e-mail message), for example, via the external terminal 32 to the terminal device 1c. Specifically, a malicious person determines in advance a target (a specific enterprise or the like) for fraudulent acquisition or the like of information and sends an e-mail message with attached malware to the target terminal device (the terminal device 1c) (this is hereinafter also called a targeted attack).

In this case, there is a possibility that the firewall device 3 is not able to determine that the e-mail message sent from the external terminal 32 is an e-mail message to be discarded and sends the e-mail message to the terminal device 1c. Therefore, as illustrated in FIG. 2, when the user executes the malware attached to the sent e-mail message, the terminal device 1c is infected with malware in some cases.

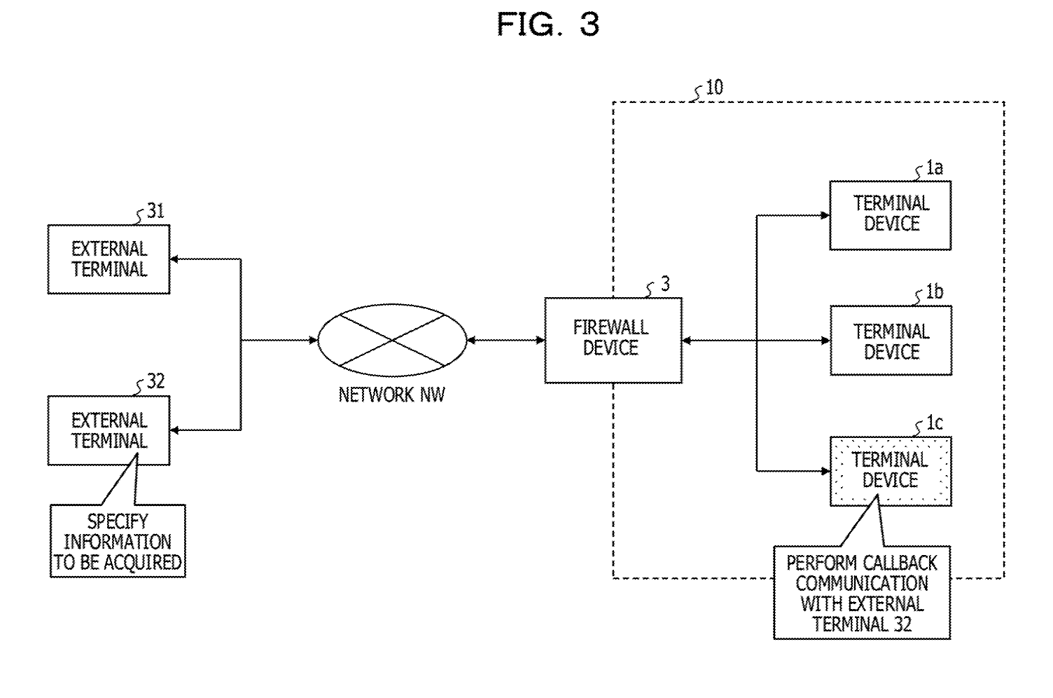

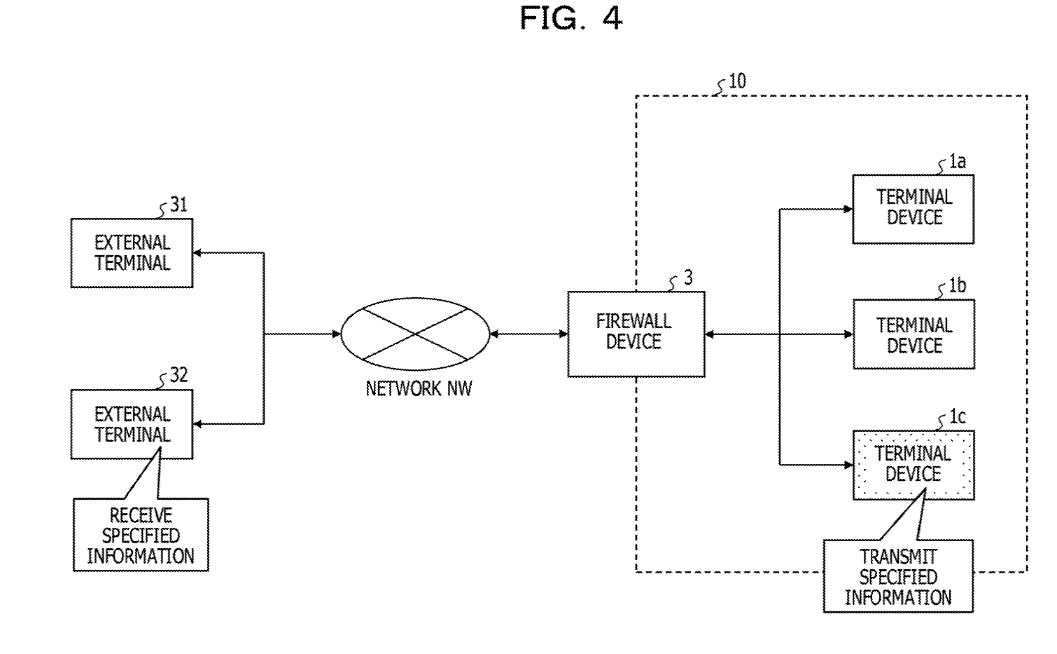

Further, in this case, the malware with which the terminal device 1c (hereinafter also called an infected terminal 1c) is infected performs callback communication with the external terminal 32, as illustrated in FIG. 3. Then, this malware, for example, waits until an instruction concerning specific content of an action to be executed (for example, a specification of information to be acquired) is received from the malicious person. Thereafter, as illustrated in FIG. 4, upon receiving an instruction via the external terminal 32 from the malicious person, the infected terminal 1c starts, for example, an operation for performing fraudulent acquisition or the like of information (hereinafter also called a malicious operation) in accordance with the content of the instruction. This allows the malicious person to, for example, perform fraudulent acquisition or the like of information owned by the target (an enterprise or the like) of a targeted attack.

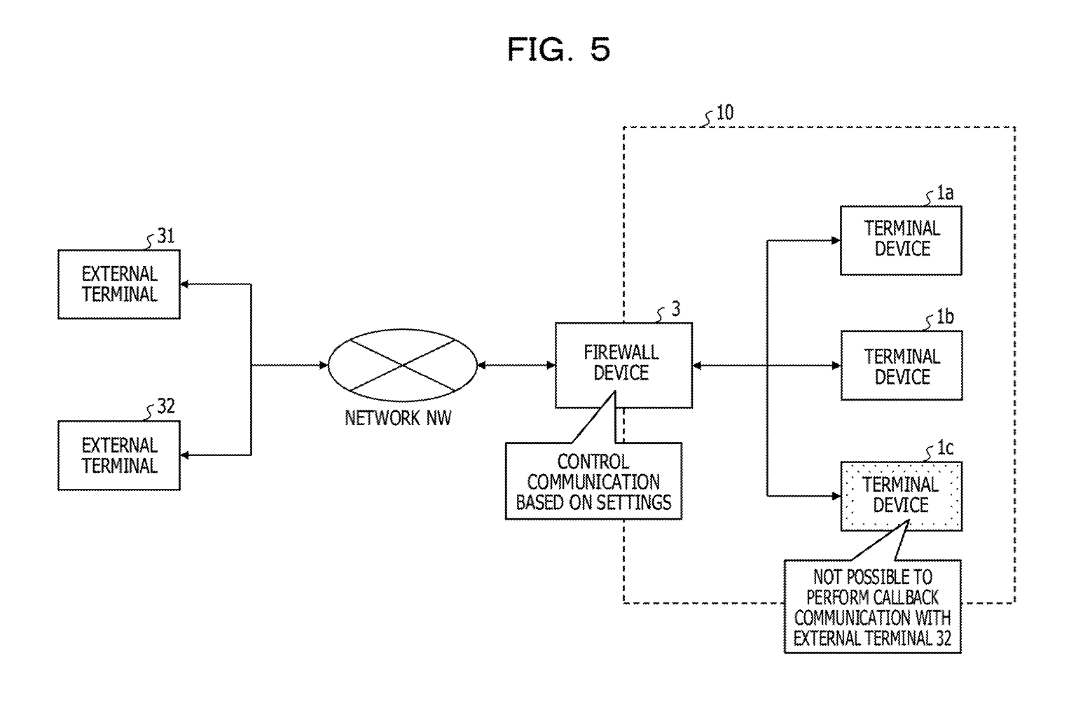

To address this, as illustrated in FIG. 5, the administrator performs settings for prohibiting communication between the infected terminal 1c and the external terminal 32, for example, in a network device (including a switch device, a router device, and the like), such as the firewall device 3 or the like that relays communication between the infected terminal 1c and the external terminal 32. That is, the administrator inhibits information from fraudulent acquisition or the like performed by a malicious person by interrupting callback communication performed between the infected terminal 1c and the external terminal 32. This allows the administrator to inhibit information from fraudulent acquisition or the like even when infection of the terminal 1c has occurred.

However, when the infected terminal 1c is a portable terminal device, in some locations where the infected terminal 1c is used, the infected terminal 1c may bypass the firewall device 3 or the like in which setting has been performed, and perform communication with the external terminal 32. Therefore, for example, when the infected terminal 1c is used outside the company, or the like, the administrator is not able to interrupt callback communication.

For this situation, in some cases, the administrator installs a program for executing a process of controlling communication (hereinafter also called a first program), in the OS, in each terminal device 1. Hereinafter, a specific example of the case where the first program, in the OS, is installed in the terminal device 1 will be described.

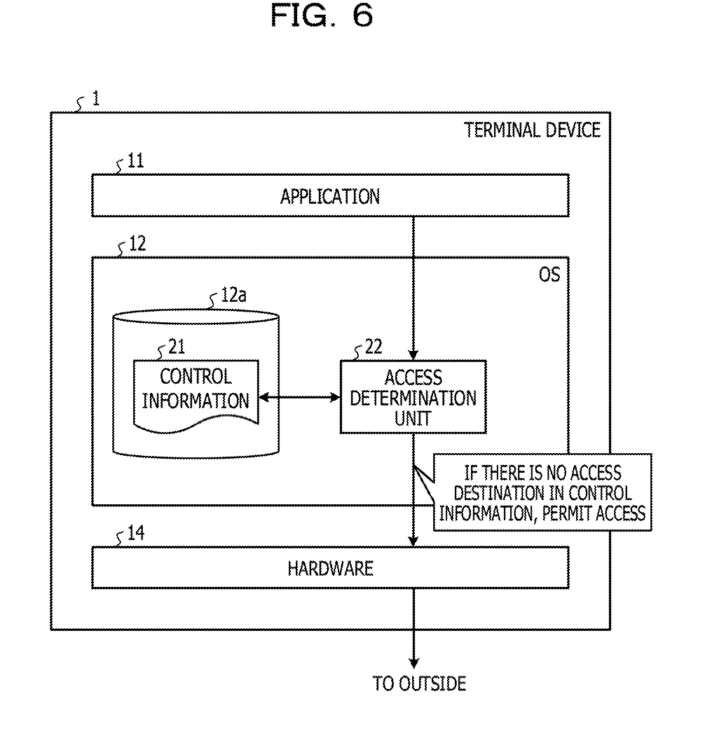

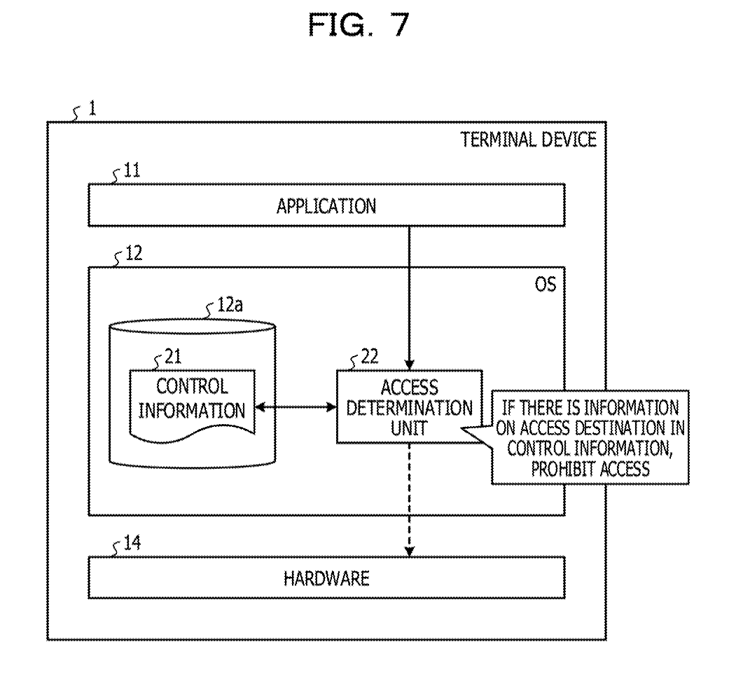

FIG. 6 and FIG. 7 are diagrams for explaining a specific example of the case where the first program, in the OS, is installed in the terminal device 1. In the terminal device 1 illustrated in each of FIG. 6 and FIG. 7, an OS 12 runs on the hardware 14, and an application 11 runs on the OS 12.

Additionally, in the OS 12, an access determination unit 22 implemented by the first program and a central processing unit (CPU) (not illustrated) of the terminal device 1 collaborating together. Further, in a storage unit 12a of the OS 12, for example, control information 21 including the IP address of a terminal device with which communication is to be prohibited (for example, the external terminal 32 that has sent malware) or the IP address of a terminal device with which communication is to be permitted is stored.

Specifically, upon receiving an access request to the outside of the terminal device 1 transmitted from the application 11, the access determination unit 22 references the control information 21 stored in the storage unit 12a, and determines whether or not information to the effect that access to the access destination of the received access request is prohibited is included. Then, if information to the effect that access to the access destination of the received access request is prohibited is not included, as illustrated in FIG. 6, the access determination unit 22 permits access corresponding to the access request, and instructs the hardware 14 to perform that access. On the other hand, if information to the effect that access to the access destination of the received access request is prohibited is included in the control information 21, as illustrated in FIG. 7, the access determination unit 22 prohibits access corresponding to the access request. That is, in this case, the access determination unit 22 does not instruct the hardware 14 to perform that access, and discards the received access request.

This enables each terminal device 1 to prohibit access corresponding to an access request received from the application 11 when the access destination of access corresponding to the access request from the application 11 is a terminal device to which access is prohibited. Therefore, the administrator is allowed to interrupt callback communication regardless of the location where the terminal device 1 is used.

However, when malware with which the infected terminal 1c is infected is malware that performs advanced operations, control of the OS in the infected terminal 1c is likely to be taken over by the malware. Then, in this case, processing for interrupting callback communication performed by the OS is likely to be not performed, making it unlikely to interrupt callback communication.

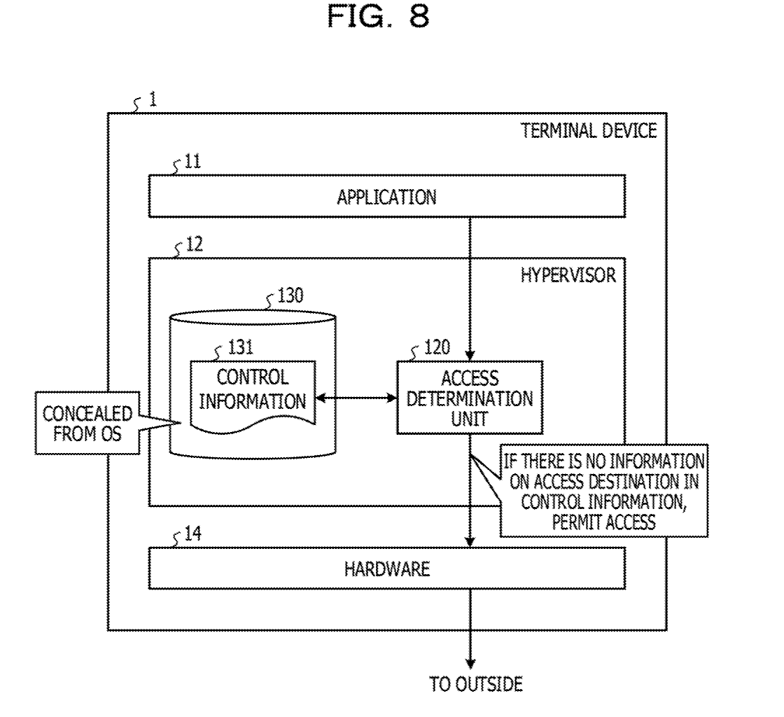

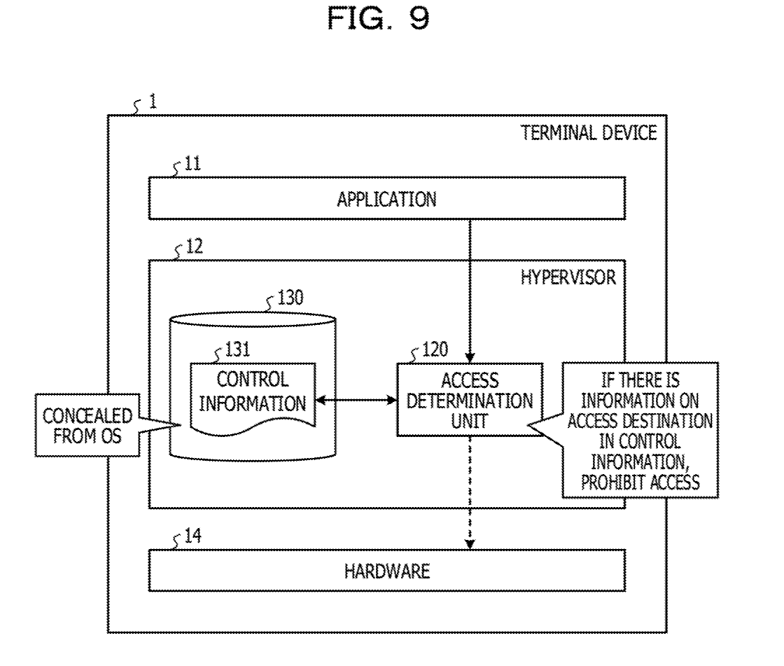

To address this, in the present embodiments, as illustrated in FIG. 8 and FIG. 9, a hypervisor 13 of the terminal device 1 includes a storage unit 130 that stores control information 131 for controlling an accessible access destination. Further, the terminal device 1 includes a processing unit 120. The processing unit 120 runs the OS 12 of the terminal device 1 under a condition where the storage unit 130 is concealed, and, when provided, from the application 11, an access request to the access destination, references the control information 131 and determines whether or not to permit access in response to the access request. Hereinafter, a specific example of the terminal device 1 of the present embodiments will be described.

FIG. 8 and FIG. 9 are diagrams for explaining a specific example of the terminal device 1 in the present embodiments. In the terminal device 1 illustrated in FIG. 8 and FIG. 9, the hypervisor 13 runs on the hardware 14, the OS 12 (the OS 12 is a virtual OS generated by the hypervisor 13 and is hereinafter also called a virtual OS 12) runs on the hypervisor 13. In the terminal device 1 illustrated in FIG, 8 and FIG. 9, the application 11 runs on the virtual OS 12.

Further, in the hypervisor 13, and also in the virtual OS 12, the processing unit 120 operates. The processing unit is implemented by a program 110 described below and a CPU 101 described below collaborating together. Additionally, the control information 131 that includes, for example, the IP address of a terminal device with which communication is to be prohibited (for example, the external terminal 32 that has sent malware) is stored in the storage unit 130 of the hypervisor 13 (in reality, part of a storage area of the hardware 14).

Specifically, upon receiving an access request to the outside of the terminal device 1 transmitted from the application 11, the processing unit 120 references the control information 131 stored in the storage unit 130. Further the processing unit 120 determines whether or not information to the effect that access to the access destination of the received access request is prohibited is included in the control information 131. As a result, if the information to the effect that access to the access destination of the received access request is prohibited is not included in the control information 131, as illustrated in FIG. 8, the processing unit 120 permits access corresponding to the access request and instructs the hardware 14 to perform that access. On the other hand, if the information to the effect that access to the access destination of the received access request is prohibited is included in the control information 131, as illustrated in FIG. 9, the processing unit 120 prohibits access corresponding to the access request. Therefore, in this case, the processing unit 120 does not instruct the hardware 14 to perform access corresponding to the access request, and discards the received access request.

That is, in the terminal device 1 in the present embodiments, a determination of whether or not to permit access corresponding to the access request is performed on the hypervisor 13. This enables the terminal device 1 to prohibit access corresponding to an access request from the application when the access destination of the access request is included in the control information 131, regardless of the location where the terminal device 1 is used. Additionally, even when control of the virtual OS 12 has been taken over by malware running as the application 11, the terminal device 1 may continue to perform a determination of whether or not to permit access.

Additionally, the hypervisor 13 of the terminal device 1 in the present embodiments conceals the storage unit 130 from the virtual OS 12. This enables the terminal device 1 to inhibit the control information 131 from being damaged by malware.

Note that the hypervisor 13 described in conjunction with FIG. S and FIG. 9 is not a hypervisor running on the OS but a hypervisor running directly on the hardware 14 (a Type-1 hypervisor). In contrast, the hypervisor 13 may be a hypervisor (a Type-2 hypervisor) running on an OS (a host OS, not illustrated) running directly on the hardware 14.

However, in the Type-1 hypervisor, as different from a Type-2 hypervisor, there is no OS between the hardware and the hypervisor. Therefore, if control of an OS that is present between the hardware and the hypervisor is likely to be taken over by malware, it is desirable that the hypervisor 13 be a Type-1 hypervisor.

### Hardware Configuration of Terminal Device

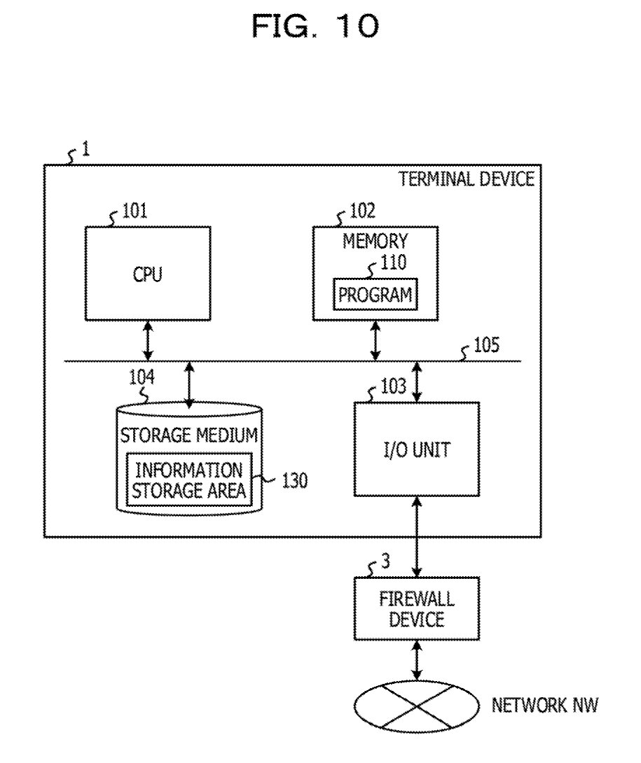

Next, the hardware configuration of the terminal device 1 will be described. FIG. 10 is a diagram for explaining a hardware configuration of the terminal device 1.

The terminal device 1 includes a CPU 101, which is a processor, a memory 102, an external interface (input/output (I/O) unit) 103, and a storage medium 104. Each unit is coupled to one another via a bus 105.

With regard to the storage medium 104, the program 110 for executing a process of controlling communication with the outside of the terminal device 1 (hereinafter also called a communication control process), or the like, is stored in a program storage area (not illustrated) within the storage medium 104.

As illustrated in FIG. 10, during execution of the program 110, the CPU 101 loads the program 110 from the storage medium 104 onto the memory 102 and collaborates with the program 110 to perform the communication control process or the like.

The storage medium 104, for example, includes an information storage area 130 (hereinafter also called the storage unit 130) that stores information used when the information control process or the like is performed. The external interface 103 performs communication with the network NW via the firewall device 3.

Note that the hardware 14 described in conjunction with FIG. 8 and FIG. 9 may correspond to the storage medium 104.

### Software Configuration of Terminal Device

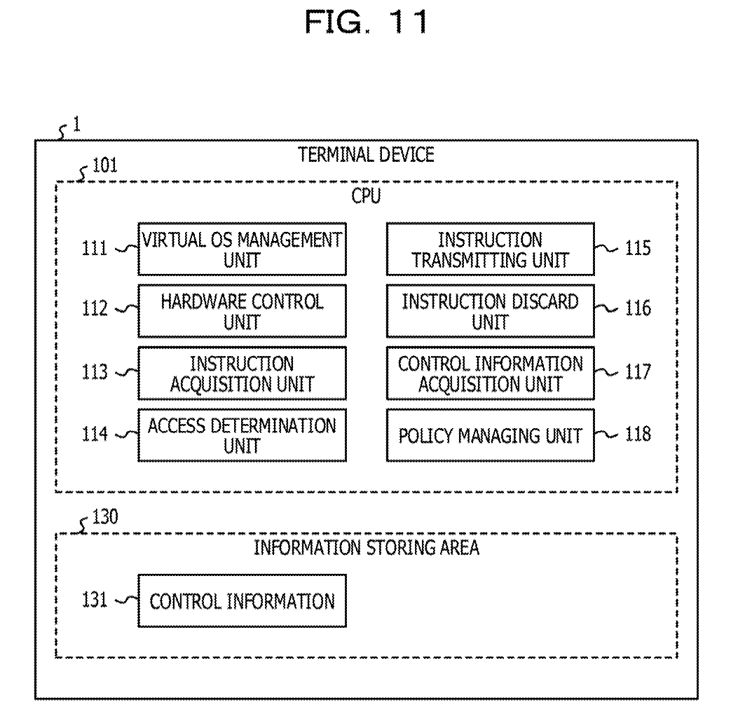

Next, the software configuration of the terminal device 1 will be described, FIG. 11 is a functional block diagram of the terminal device 1 in FIG. 10. The CPU 101 collaborates with the program 110, thereby operating as a virtual OS management unit 111, a hardware control unit 112, an instruction acquisition unit 113, an access determination unit 114, an instruction transmitting unit 115, and an instruction discard unit 116, which are the functionality of the hypervisor 13 of the terminal device 1. The CPU 101 also collaborates with the program 110, thereby operating as a control information receiving unit 117 and a control information management unit 118, which are the functionality of the hypervisor 13 of the terminal device 1. Additionally, in the information storage area 130 (hereinafter also called the storage unit 130), control information 131 is stored. Note that the, processing unit 120 described in conjunction with FIG. 8 and FIG. 9 corresponds to, for example, the hardware control unit 112, the instruction acquisition unit 113, the access determination unit 114, the instruction transmitting unit 115, and the instruction discard unit 116.

The virtual OS management unit 111 performs generation and deletion of the virtual OS 12 in the terminal device 1, for example, in response to input from the administrator.

Additionally, if, among already generated virtual OSs 12, there is a virtual OS 12 in which the usage of the CPU 101, the usage of the memory 102, or the like exceeds a given upper threshold, the virtual OS management unit 111, for example, performs generation of a new virtual OS 12. Further, if, among already generated virtual OSs 12, there is a virtual OS 12 in which the usage of the CPU 101, the usage of the memory 102, or the like is lower than a given lower threshold, the virtual OS management unit 111, for example, performs deletion of the already generated virtual OS 12. This enables the virtual OS management unit 111 to effectively use physical resources (the CPU 101, the memory 102, the hardware 14 (the storage medium 104), and the like) of the terminal device 1.

The hardware control unit 112 controls physical resources that are assigned to the virtual OSs 12 running on the hypervisor 13. Specifically, the hardware control unit 112 assigns physical resources of the terminal device 1 to each virtual OS 12 generated by the virtual OS management unit 111.

Additionally, the hardware control unit 112 runs the virtual OSs 12 under a condition where the control information 131 (the storage unit 130) is concealed. Specifically, when the terminal device 1 is activated, the terminal device 1 launches the hypervisor 13 and then launches the virtual OS 12. This enables the hypervisor 13 to conceal the presence of the storage unit 130 from the virtual OS 12 when the virtual OS 12 is launched.

Note that the administrator may separately provide a storage medium in which information for launching the virtual OS 12 is stored and a storage medium in which information for launching the hypervisor 13 is stored. This enables the terminal device 1 to easily control the order in which the hypervisor 13 and the virtual OS 12 are launched.

When given an access request to the access destination (for example, the outside of the terminal device 1) by the application 11 via the virtual OS, the instruction acquisition unit 113 acquires (hooks) that access request prior to being transmitted to the hardware 14.

When the instruction acquisition unit 113 acquires the access request from the application 11, the access determination unit 114 controls the access destination of the access request, based on the control information 131 stored in the information storage area 130. Specifically, if information to the effect that access to the access destination of the access request is prohibited is included in the control information 131, the access determination unit 114 prohibits access to that access destination. Alternatively, if information to the effect that access to the access destination corresponding to the access request is prohibited is not included in the control information 131, the access determination unit 114 permits access to that access destination Specific examples of the control information 131 will be described below.

If the access determination unit 114 permits access corresponding to an access request from the application 11, the instruction transmitting unit 115 transmits that access request to the hardware 14. Then, having received the access request, the hardware 14 performs access to the access destination of the access request.

If the access determination unit 114 prohibits access corresponding to the access request from the application 11, the instruction discard unit 116 discards that access request. That is, in this case, the terminal device 1 does not perform access to the access destination.

The control information receiving unit 117 receives, for example, the control information 131 transmitted via an administrator terminal (not illustrated) by the administrator. Then, the control information management unit 118 stores the control information 131 received by the control information receiving unit 117 in the information storage area 130.

### Outline of First Embodiment

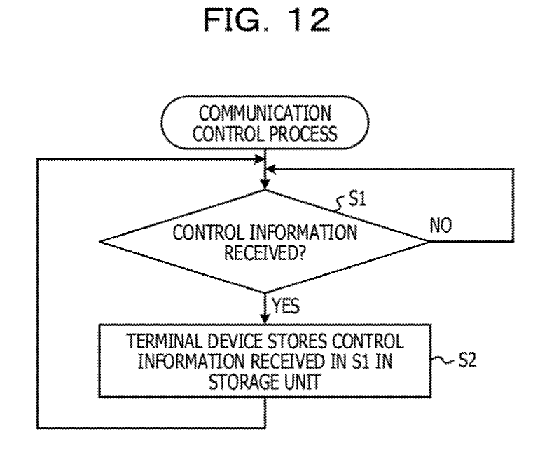

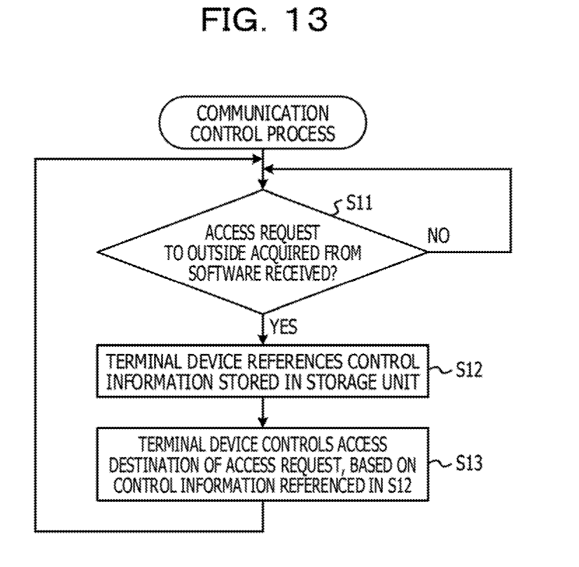

Next, the outline of a first embodiment will be described. FIG. 12 and FIG. 13 are flowcharts for explaining the outline of a communication control process in the first embodiment.

### Control Information Storing Process

First, a process performed when the hypervisor 13 of the terminal device 1 stores the control information 131 in the information storage area 130 (hereinafter also called a control information storing process) will be described.

As illustrated in FIG. 12, the terminal device 1 (the hypervisor 13), for example, waits until the control information 131 transmitted via an administrator terminal by the administrator is received (No in S1). If the control information 131 is received (Yes in S1), the terminal device 1 stores the control information 131 acquired in the process in S11 in the information storage area 130 (S2).

Note that, when the terminal device 1 is activated, the hypervisor 13 in the present embodiments is launched earlier than the virtual OS 12. This enables the hypervisor 13 to run the virtual OS 12 under a condition where the control information 131 (the information storage area 130) is concealed. Therefore, even when control of the virtual OS 12 is taken over by malware executed on the application 11, it is enabled to inhibit the control information 131 from being damaged by malware.

### Access Permission or Prohibition Determination Process

Next, a process in which the hypervisor 13 of the terminal device 1 determines whether or not to permit access corresponding to an access request transmitted from the application 11 (hereinafter also called an access permission or prohibition determination process).

As illustrated in FIG. 13, the terminal device 1 (the hypervisor 13) waits until an access request to the outside from the application 11 of the virtual OS 12 (hereinafter they are also generically called software) is acquired (No in S11).

Then, if an access request is acquired from the application 11 (Yes in S11), the terminal device 1-references the control information 131 stored in the information storage area 130 (S12). Thereafter, based on the control information 131 referenced in the process in S12, the terminal device 1 controls the access destination of the access request acquired in the process in S11 (S13).

That is, when the application 11 running on the virtual OS 12 is infected with malware (including the case where the malware independently runs as one of applications), in order to perform callback communication with the external terminal 32 described in conjunction with FIG. 1 and the like, the malware performs an access request to the external terminal 32. Therefore, when the application 11 performs an access request to the hardware 14, the hypervisor 13 acquires that access request. Then, in this case, the hypervisor 13 determines whether or not information to the effect that access to the access destination of that access request is prohibited is included in the control information 131. As a result, if the information to the effect that access to the access destination of the access request is prohibited is included in the control information 131, the hypervisor 13 determines that the application 11 that has transmitted the access request is infected with malware. Then, in this case, the hypervisor 13 discards the access request from the application 11 without transmitting the access request to the hardware 14.

Additionally, there is a possibility that an access request for performing callback communication is performed not only from the application 11 but also from the virtual OS 12 control of which is taken over by malware. Therefore, for an access request from the virtual OS 12, the hypervisor 13 similarly performs, a determination of whether or not to permit access to the access request.

This enables the hypervisor 13 to interrupt callback communication from malware, regardless of the location where the terminal device 1 is used or regardless of whether or not control of the virtual OS 12 is taken over by malware.

In such a way, according to the first embodiment, the hypervisor 13 of the terminal device 1 includes the storage unit 130 that stores the control information 131 for controlling an accessible access destination. The hypervisor 13 of the terminal device 1 also includes the processing unit 120 that runs the virtual OS 12 under a condition where the storage unit 130 is concealed, and that, when an access request from the application 11 to another device is provided, controls the access destination of the access request based on the control information 131.

This enables the hypervisor 13 to inhibit information from fraudulent acquisition or the like performed by a malicious person even when the terminal device 1 is infected with malware.

### Details of First Embodiment

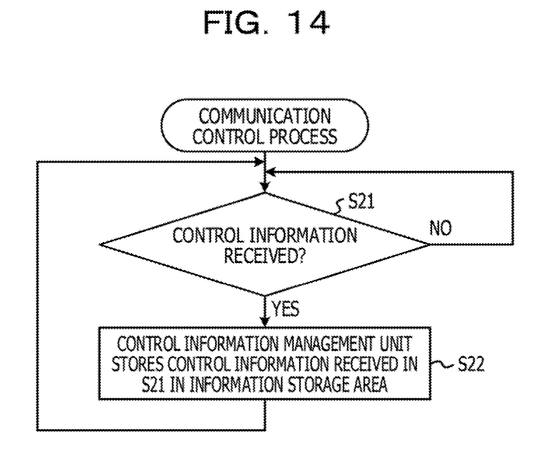

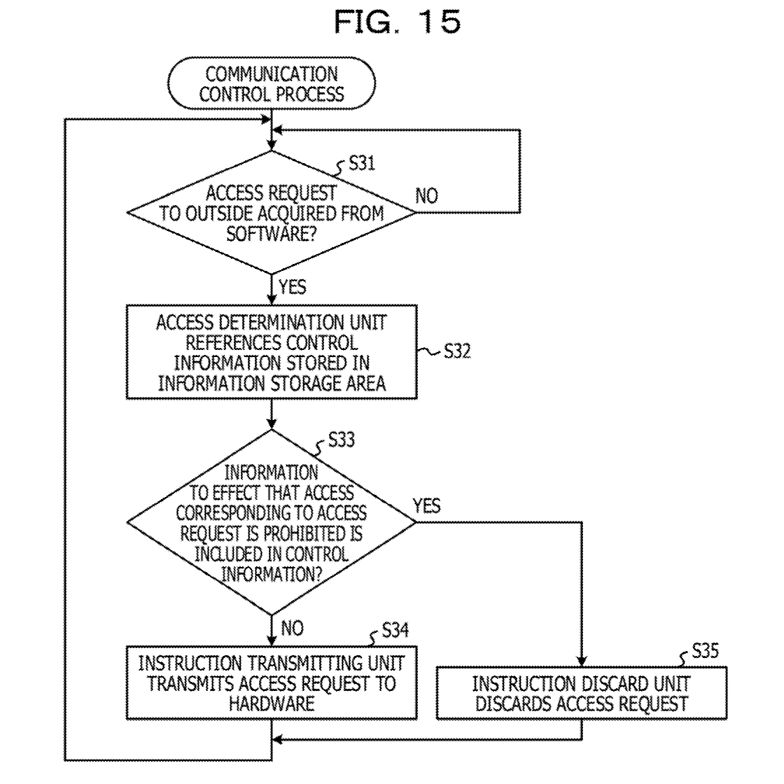

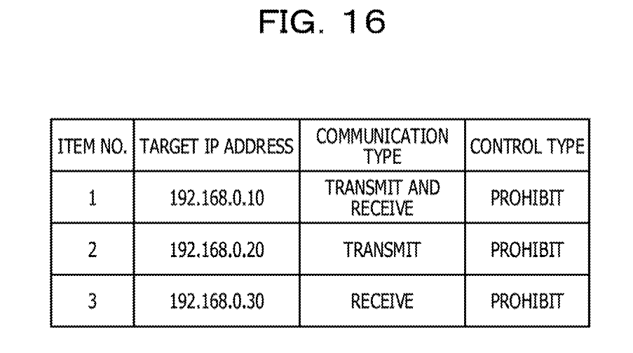

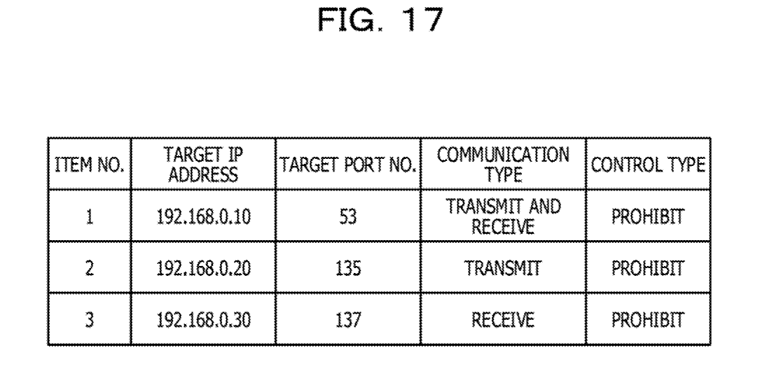

Next, details of the first embodiment will be described. FIG. 14 and FIG. 15 are flowcharts for explaining details of the communication control process in the first embodiment. FIG. 16 and FIG. 17 are diagrams for explaining details of the communication control process in the first embodiment. With reference to FIG. 16 and FIG. 17, the communication control process illustrated in FIG. 14 and FIG. 15 will be described.

### Control Information Storing Process

First, details of the control information storing process will be described. As illustrated in FIG. 14, the control information receiving unit 117 of the terminal device 1 (the hypervisor 13), for example, waits until the control information 131 transmitted via an administrator terminal by the administrator is received (No in S21). Then, if the control information 131 is received (Yes in S21), the control information management unit 118 of the terminal device 1 (the hypervisor 13) stores the control information 131 acquired in the process in S21 in the information storage area 130 (S22). Specific examples of the control information 131 will be described below.

### Specific Examples of Control Information

FIG. 16 is a diagram for explaining a specific example of the control information 131. The control information 131 depicted in FIG. 16 includes, as items, “Item No.” that identifies each information included in the control information 131 and “Target IP Address” for setting the IP address of an access destination to which access is permitted or prohibited. The control information 131 depicted in FIG. 16 also includes, as items, “Communication Type” for setting any of communication types (Transmit and Receive, Transmit, and Receive) for which permission or prohibition of access is made, and “Control Type” for setting either permission or prohibition for access.

Specifically, in the control information 131 depicted in FIG. 16, for information whose “Item No.” is “1”, “192.168.0.10” is set as the “Target IP Address”, “Transmit and Receive” is set as “Communication Type”, and “Prohibit” is set as “Control Type”. Additionally, in the control information 131 depicted in FIG. 16, for information whose “Item No,” is “2”, “192.168.0.20” is set as “Target IP Address”, “Transmit” is set as “Communication Type”, and “Prohibit” is set as “Control Type”. Further, in the control information 131 depicted in FIG. 15, for information whose “Item No.” is “3”, “192.168.0.30” is set as “Target IP Address”, “Receive” is set as “Communication Type”, and “Prohibit” is set as “Control Type”.

That is, the control information 131 depicted in FIG. 16 includes information to the effect that transmitting of information to a terminal device whose “Target IP Address” is “192.168.0.10” and receiving of information from the terminal device whose “Target IP Address” is “192.168.0.10” are prohibited. Further, the control information 131 depicted in FIG. 16 includes information to the effect that transmitting of information to a terminal device whose “Target IP Address” is “192.168.020” and receiving of information from a terminal device whose “Target IP Address” is “192.168.0.30” are prohibited.

This enables the terminal device 1 to interrupt communication included in the control information 131 (for example, callback communication), as described below. Therefore, even when the terminal device 1 infected with malware is present, the administrator is enabled to inhibit information from fraudulent acquisition or the, like performed using that terminal device 1 as a stepping-stone.

Note that information on an access destination to which access is prohibited is set in the control information 131 depicted in FIG. 16. In contrast, information on an access destination to which access is permitted may be set in the control information 131. In this case, the terminal device 1 may permit only communication with an access destination on which information is included in the control information 131. This enables the administrator to interrupt callback communication even if the administrator does not grasp information on an access destination when callback communication is performed.

### Access Permission or Prohibition Determination Process

Next, details of the access permission or prohibition determination process will be described. As illustrated in FIG. 15, the instruction acquisition unit 113 of the terminal device 1 (the hypervisor 13) waits until an access request to the outside is acquired from software (the application 11 and the virtual OS 12) (No in S31). Thereafter, if the instruction acquisition unit 113 acquires the access request from the software (Yes in S31), the access determination unit 114 of the terminal device 1 references the control information 131 stored in the information storage area 130 (S32). Then, based on the control information 131 referenced in the process in S32, the access determination unit 114 determines whether or not the access destination of the access request acquired in the process in S31 is included in the control information 131 (S33).

As a result, if information to the effect that access to the access destination of the acquired access request is prohibited is not included in the control information 131 (No in S33), the instruction transmitting unit 115 of the terminal device 1 transmits the acquired access request to the hardware 14 (S34). That is, in this case, the access determination unit 114 determines that the application 11 or the virtual OS 12 that has transmitted the access request is not infected with malware. Therefore, in this case, the instruction transmitting unit 115 instructs the hardware 14 to perform access in response to the access request acquired in the process in S31.

On the other hand, if information to the effect that access to the access destination of the access request acquired in the process in S31 is prohibited is included in the control information 131 (Yes in S33), the instruction discard unit 116 of the terminal device 1 discards the acquired access request (S35). That is, in this case, the access determination unit 114 determines that the application 11 or the virtual OS 12 that has transmitted the access request acquired in the process in S31 is malware, Then, the access determination unit 114 determines that the access request acquired in the process in S31 is likely to be callback communication. Therefore, in this case, the instruction transmitting unit 115 does not instruct the hardware 14 to perform access in response to the access request acquired in the process in S31.

This enables the terminal device 1 to inhibit information from fraudulent acquisition or the like performed by a malicious person even when the application 11 or the virtual OS 12 is infected with malware. Therefore, the administrator is enabled to continue to use, for example, a terminal device coupled to the same network as the terminal device 1 whose infection with malware is detected (a terminal device that is likely to have been infected with malware with which the terminal device 1 has been infected).

Additionally, the terminal device 1 performs communication control in the hypervisor 13, not in a network device or the like outside the terminal device 1. Therefore, the terminal device 1 is enabled to interrupt communication to be interrupted, regardless of the location where the terminal device 1 is used.

Further, since the storage unit 130 is concealed from the virtual OS 12 by the hypervisor 13, the terminal device 1 is enabled to inhibit the control information 131 from damage or the like caused by malware with which the application 11 or the virtual OS 12 is infected.

### Another Specific Example of Control Information

Next, another specific example of the control information 131 will be described. FIG. 17 is a diagram for explaining another specific example of the control information 131. The control information 131 depicted in FIG. 17 includes “Target Port No.” for setting the port number of an access destination, as an item, in addition to information included in the control information 131 described in conjunction with FIG. 16. This enables the terminal device 1 (the hypervisor 13) to perform, in more detail, a determination of whether or not to prohibit access corresponding to an access request transmitted from the application 11 or the virtual OS 12.

Specifically, in the control information 131 depicted in FIG. 17, for information whose “Item No.” is “1”, “192.168.0.10” is set as “Target IP Address”, and “53” is set as “Target Port No.”, Additionally, in the control information 131 depicted in FIG. 17, for information whose “Item No.” is “1”, “Transmit and Receive” is set as “Communication Type”, and “Prohibit” is set as “Control Type”. Description of other information in FIG. 17 is omitted.

This enables the administrator to interrupt only communication related to partial functionality when there is a possibility that the terminal device 1 has been infected with malware, Therefore, the administrator is enabled to permit, for example, only communication related to a process that has to be continuously executed, among processes executed by the terminal device 1.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication device comprising:
a memory configured to store information that defines permission and prohibition of access to another communication device from the communication device; and
a processor coupled to the memory and configured to:
in a state where the information is not referenced by an operating system (OS), run the OS,
when an access request to the another communication device is received from an application, based on the information, perform a determination of permission or prohibition of access to the another communication device, and
based on a result of the determination, perform accessing to the another communication device or rejecting the access request.

2. The communication device according to claim 1, wherein
the processor functions as a hypervisor that performs generation and deletion of the OS and a virtual machine, and
the hypervisor is configured to, upon receiving the access request from the application, perform a determination of permission and prohibition of the access to the another communication device based on the information.

3. The communication device according to claim 2, wherein
the hypervisor is configured to run without involving the OS.

4. The communication device according to claim 1, wherein
the processor is configured to, when the information defines prohibition of access to the another communication device, prohibit access to the another communication device, and, when the information defines permission to access the another communication device, permit access to the another communication device.

5. The communication device according to claim 4, wherein
the information includes an address of an access destination to which the access is prohibited, and
the processor is configured to, when the address of the another communication device is included in the information, prohibit the access to the another communication device, and, when the address of the another communication device is not included in the information, permit the access to the another communication device.

6. The communication device according to claim 4, wherein
the information includes ad address of an access destination to which the access is permitted, and
the processor is configured to, when the address of the another communication device is not included in the information, prohibit the access to the another communication device, and, when the address of the another communication device is included in the information, permit the access to the another communication device.

7. The communication device according to claim 3, wherein
the OS runs on the hypervisor, and
the application runs on the OS.

8. The communication device according to claim 1, wherein
the another communication device is configured to send malware to the communication device, and
in response to the sending of the malware, the application is configured to generate the access request to the another communication device.

9. The communication device according to claim 2, wherein
when the communication device is activated, the OS is activated after the hypervisor is activated.

10. A method using a communication device comprising:
storing, in the communication device, information that defines permission and prohibition of access to another communication device from the communication device;
in a state where the information is not referenced by an operating system (OS), running the OS;
when an access request to the another communication device is received from an application, based on the information, performing, by the communication device, a determination of permission or prohibition of access to the another communication device; and
based on a result of the determination, performing, by the communication device, accessing to the another communication device or rejecting the access request.

11. The method according to claim 10, wherein
the communication device includes a memory and a processor coupled to the memory,
the information is stored in the memory,
the processor functions as a hypervisor that performs generation and deletion of the OS and a virtual machine, and
the hypervisor is configured to, upon receiving the access request from the application, perform a determination of permission and prohibition of the access to the another communication device based on the information.

12. The method according to claim 11 wherein
the hypervisor is configured to run without involving the OS.

13. The method according to claim 10, wherein
when the information defines prohibition of access to the another communication device, the accessing to the another communication device is performed, and, when the information defines permission to access the another communication device, the rejecting the access request is performed.

14. The method according to claim 13, wherein
the information includes an address of an access destination to which the access is prohibited, and
when the address of the another communication device is included in the information, the rejecting the access request is performed, and, when the address of the another communication device is not included in the information, the accessing to the another communication device is performed.

15. The method according to claim 13, wherein
the information includes ad address of an access destination to which the access is permitted, and
when the address of the another communication device is not included in the information, the rejecting the access request is performed, and, when the address of the another communication device is included in the information, the accessing to the another communication device is performed.

16. The method according to claim 12, wherein
the OS runs on the hypervisor, and
the application runs on the OS.

17. The method according to claim 10, further comprising:
receiving malware, by the communication device from the another communication device; and
in response to the receiving of the ma are, generating the access request to the another communication device.

18. The method according to claim 11, further comprising:
when the communication device is activated, activating the OS after the hypervisor is activated.

19. A non-transitory computer-readable storage medium storing a program that causes a communication device to execute a process, the process comprising:
storing, in the communication device, information that defines permission and prohibition of access to another communication device from the communication device;
in a state where the information is not referenced by an operating system (OS), running the OS;
when an access request to the another communication device is received from an application, based on the information, performing a determination of permission or prohibition of access to the another communication device; and
based on a result of the determination, performing access to the another communication device or reject the access request.

20. The non-transitory computer-readable storage media according to claim 19, wherein
the communication device includes a memory and a processor coupled to the memory,
the information is stored in the memory,
the processor functions as a hypervisor that performs generation and deletion of the OS and a virtual machine, and
the hypervisor is configured to, upon receiving the access request from the application, perform a determination of permission and prohibition of the access to the another communication device based on the information.
